(19) United States
(12) Patent Application Publication
(10) Pub. No.: US 2011/0219689 A1
(43) Pub. Date: Sep. 15, 2011

(54) Botanical Arrangement and Display Apparatus

(75) Inventor: Julien Thomas Hodson-Walker, Kuala Lumpur (MY)

(73) Assignee: Julien Thomas Hodson-Walker, Kuala Lumpur (MY)

(21) Appl. No.: 13/127,181

(22) PCT Filed: Nov. 5, 2009
(86) PCT No.: PCT/MY2009/000187

§ 371 Date: May 13, 2011

(30) Foreign Application Priority Data
Nov. 6, 2008 (MY) 2008 4440

(51) Int. Cl. A01G 9/02; A01G 1/00

(52) U.S. Cl. 47/66.6; 47/66.7

(57) ABSTRACT

The invention relates to an apparatus for the arrangement and display of botanical specimens. In particular, the invention relates to supporting plants within a confined environment or where a vertical arrangement is required. The invention provides a planter assembly (2) for the growth and/or display of plants comprising at least one side support panel (10; 110) having a longitudinal axis and one or more plant supports (30; 130) connected to the at least one side support panel for supporting a plurality of plants in at least one row and/or column extending in a plane at an oblique angle to the longitudinal axis of the at least one side support panel.

### FIELD OF THE INVENTION

The present invention relates to an apparatus for the arrangement and display of botanical specimens. In particular, the invention relates to supporting plants within a confined environment or where a vertical arrangement is required.

### BACKGROUND TO THE INVENTION

Plants and other botanical specimens may be propagated for a wide range of commercial and domestic purposes. These include decorative, aesthetic and ornamental purposes as well as for scientific study, landscaping and food production purposes. Plants may be supported and arranged in a variety of ways and may be housed individually or collectively in containers, on artificial supports or grown directly in the ground. Growth media for the plants can comprise soil, sand and/or a variety of artificial substrates and media.

In certain circumstances it may be desirable to elevate some of the plants. This may be in order to adapt the growth and/or display of the plants to a particular physical environment. For instance, certain domestic, industrial, public, or corporate environments may have limited available space or wish to maximise the efficiency with which the space is utilised. Additionally, the elevation of plants may promote the visual and aesthetic properties of the plants.

In an attempt to grow or display plants vertically, in some instances it has been necessary to initially pre-grow the plants in a separate place before transporting and arranging the display. For instance, the plants may be grown, established or prepared in a horizontal arrangement prior to being elevated into a vertical position for display or further growth. In some such circumstances, small plants such as mosses may be grown directly on a solid substrate, or plants may be grown within thin layers of growth substrate that are enclosed within a support mesh or frame. Once growth has been established, the frames are then hung or mounted onto a vertical support structure. The necessity for such a two-stage process incorporates inefficiency, expense and time-delay into the overall preparation and arrangement on the plants.

Another system for vertical growth and/or display of plants is through the use of climbing plants such as vines or trees that may be trained to grow up a wall trellis, mesh, espalier, or lattice structure. While this system has been effectively used for many applications, it is limited to the use of a narrow range of climbing plants. A further limitation of this system is the delay between the initial setup and the development of the display through the growth of the plants. This system is also only suited to permanent or semi-permanent plantings and does not facilitate plant replacement or rotation.

Modular systems such as those incorporating thin layers of growth media, permit the growth of moss or small plants which have a limited rooting zone, and can produce a uniform display effect. However, these systems are also more suited to permanent or semi-permanent displays of a single plant variety. Most existing systems for vertical plant arrangement are also only suited to display in a single orientation or viewing from one direction.

Systems incorporating large pre-grown modules are also significantly heavy, bulky and cumbersome, requiring considerable effort to lift into place and assemble. Moreover, although modular systems also facilitate uniform monoculture arrangements, they are not easily adapted to fine detail decorative aesthetic displays or to the replacement or rotation of individual plants.

Pots, planters and troughs have also been placed on ledges, racks and shelves, in order to provide elevation these simple systems being easily established and maintained. Unfortunately the predominant visual effect is the side view of the pot or planter rather than the foliage or flowers of the plant. This type of system also prohibits vertical growth and promotes lateral plant growth, and is therefore primarily suited to trailing and lateral plant growth.

Still further flower displays systems have been used to create geometric landscaping designs. Some of these have been customised to specific shapes into which plants are securely mounted. These allow detailed ornate designs to be produced, however, the plants must firstly be removed from their pots and wrapped in a sponge before being housed in a specific plant casing and secured into the display frame using a customised pot buckle or clip.

### SUMMARY OF THE INVENTION

According to one aspect of the present invention, there is provided a wall-mountable planter assembly for the growth and/or display of plants comprising: at least one planar side support panel (10, 110) having a longitudinal axis; one or more plant supports (30,130) connected to an inner surface of the at least one planar side support panel and configured to support, in use, a plurality of plants in at least one row and/or column extending in a plane at an oblique angle to the longitudinal axis of the at least one side support panel; and mounting means for mounting the assembly to a wall or to at least one rail or cable.

In a preferred embodiment, the or each plant support has a front edge zone and a rear edge zone and a line joining the front edge zone and a line joining the front edge zone to the rear edge zone extends at an oblique angle to the longitudinal axis of the at least one side support panel.

Preferably, the or each plant support has a plurality of pot receiving apertures for accommodating a plurality of plant pots. Additionally the or each plant support has front and rear members extending from the at least one side support members and a plurality of transverse members joining the front and rear members to define the pot receiving apertures.

It is also preferred that the transverse members extend at an oblique angle to the longitudinal axis of the at least one side support panel.

Preferably, the plant angle of each plant is uniform. The plant angle preferably falls substantially in the range from 10° to 80°, more preferably from 20° to 70°, a plant angle of about 30° being particularly preferred.

Preferably the at least one plant support is removably attached to the at least one side support panel. The planter assembly side panels and plant supports may be disengaged and stacked together for space efficient transport and/or storage.

Preferably, the side panels have at least one rail to which an end of one of the plant supports is attached. Upper and lower rails may be provided, the plant supports may also have locking flanges at each end. In one particular embodiment, the locking flanges are adapted to removably engage the upper and lower rails, with at least one locking nib being optionally provided to prevent excessive forward movement of the plant support.

The mounting means may include at least one stabilising hook, the at least one stabilising hook preferably being engageable with a mounting bracket. Preferably, the mounting bracket is a twist-lock bracket for engagement with a mounting rail.

Most advantageously, the planter assembly can accommodate plant pots containing soil, sand, or other planter growth medium or substrate, said plant pots being of any common shape, with square or rectangular plant pots being particularly preferred.

Preferably the plant pots are used for accommodating one or more of the botanical specimens from a wide range of species such as the following: grass, moss, flowering plants, trailing plants, epiphytes, bromeliads, vegetables, climbing plants, fruit, mushrooms, bonsai, lichen, herbs, nuts, ferns, algae, fungi, seed plants and sea weed.

It is also preferred that the plant pots are retained within the planter assembly without additional restraint, such as a clip. This enables the use of standard pots, and reduces the cost of the assembly and also reduces the amount of time required for assembly.

It is further preferred that the botanical specimen may be accommodated in the planter assembly without being removed from the plant pot in which it was propagated. To remove a plant from the pot in which it has been grown in order to place it within another vessel for the purposes of display places an undesirable stress on the plant which can result in loss of important production traits such as foliage, fruit and flower production. This transfer also increases the length of assembly time required.

Alternatively, while still utilising the preferred embodiment of the invention, the plants can be directly propagated into plant pots after the assembly of the planter assembly.

It is also preferred that the planter assembly incorporates integrated irrigation, in order that the planter assembly provides a complete system for housing and displaying plants for extended periods. Commonly available irrigation systems providing water and nutrients through irrigation conduits such as High Density PolyEthylene (HDPE) pipes are particularly preferred, being inexpensive, adaptable and easy to install.

It is further preferred that the planter assembly incorporates a plurality of plant pots, each plant pot having apertures in at least one side wall to allow the passage of water into or out of the pot. Preferably the plant pots are lined with a porous textile material.

It is particularly preferable to provide a planter assembly in which single plants can be easily removed and replaced, since in certain circumstances it may be necessary or desirable to replace an individual plant in order to rejuvenate or alter the display of flowers.

In another aspect of the invention, there is provided a pot adapted for mounting at an oblique angle (28) which comprises a top opening, a base and four side walls, whereby when the pot is mounted in use at said oblique angle one of said side walls (84) is a lower side wall, and an opposing side wall is an upper side wall, wherein: the lower side wall comprises apertures (154) positioned such that, in use at said oblique angle, a capillary reservoir (160) is formed in which a quantity of water may accumulate and whereby excess water may drip through said lower side wall apertures (154); and the upper side wall comprises apertures (152) positioned such that, in use at said oblique angle, excess water dripping through corresponding lower side wall apertures (154) of an upper pot will enter through said upper side wall apertures (152).

In a further aspect, the current invention also provides a method of using the planter assembly for the horticultural or agronomic growth and/or display of plants.

### BRIEF DESCRIPTION OF THE DRAWINGS

Preferred embodiments of the invention will now be described, by way of example only, with reference to the accompanying drawings in which:

FIG. 1 is a perspective view of a Planter Assembly according to a first preferred embodiment of the invention;

FIG. 2 is a perspective view of a Planter Assembly according to a second preferred embodiment of the invention;

FIG. 3 is a plan view of a Side Panel of the planter assembly of FIG. 1;

FIG. 4A is a front plan view of a Plant Support of the assembly of FIG. 2;

FIG. 4B is a bottom plan view of the Plant Support of FIG. 4A;

FIG. 4C is a perspective view of the Plant Support of the assembly of FIG. 1;

FIG. 5A is a front plan view of an Upper Right Rail for the assembly of FIG. 1 or FIG. 2;

FIG. 5B is a view along AA of FIG. 5A;

FIG. 5C is a view along BB of FIG. 5A;

FIG. 6A is a front plan view of an Upper Left Rail of the assembly of FIG. 1 or FIG. 2;

FIG. 6B is view along AA of FIG. 6A;

FIG. 6C is a view along BB of FIG. 6A;

FIG. 7A is a front plan view of a Lower Rail of the assembly of FIG. 1 or FIG. 2;

FIG. 7B is a view along AA of FIG. 7A;

FIG. 7C is a view along BB of FIG. 7A;

FIG. 8 is a cross sectional view showing inter-relationship of the Upper and lower Rails, and the Plant Support of the assemblies;

FIG. 9A is a perspective view of a Wall bracket

FIG. 9B is a side plan view of the Wall bracket of FIG. 9A;

FIG. 9C is a front plan view of the Wall bracket of FIG. 9A;

FIG. 9D is a top plan view of Wall bracket of FIG. 9A;

FIG. 10 is a perspective view of Stabilising Hook engagement with Wall Bracket

FIG. 11A is a cross sectional view showing the relationship of a Plant Pot with the Side Panel and Plant Support of the assembly of FIG. 1 or FIG. 2.

FIG. 11B is a schematic view showing the plant angle 28

FIG. 12A is front plan view of a hanging rail

FIG. 12B is a view along AA of FIG. 12A

FIG. 13A is a side plan view of a twist-lock bracket

FIG. 13B is a view along BB of FIG. 13A

FIGS. 14A and B are perspective views of the plant pot

FIG. 15A is a front plan view of the plant pot

FIG. 15B is a side plan view of the plant pot

FIG. 15C is a bottom plan view of the plant pot

FIG. 15D is a back plan view of the plant pot

FIG. 16 is a side view of the pot showing water flow from an upper pot to a lower pot.

### DETAILED DESCRIPTION OF THE DRAWINGS

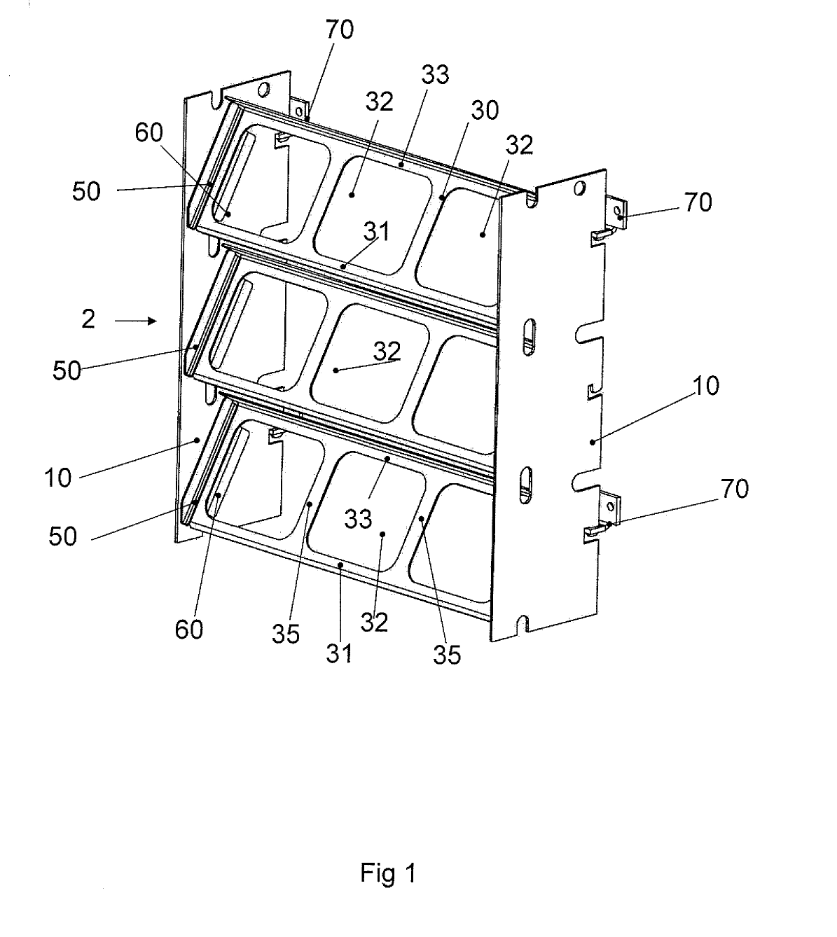

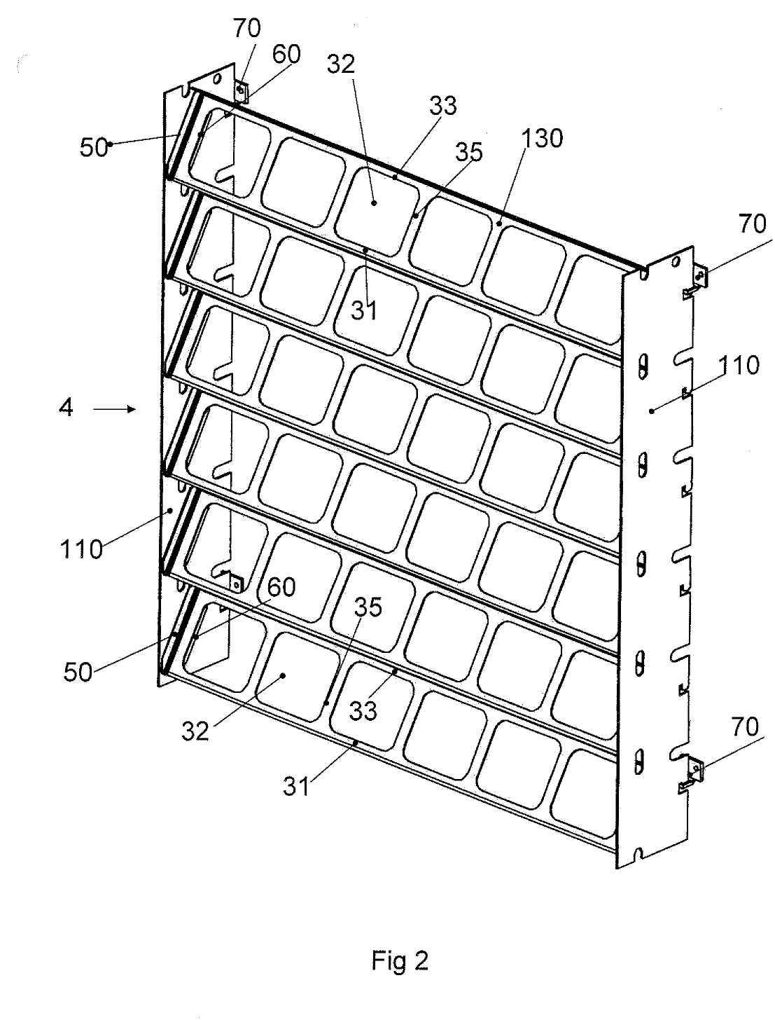

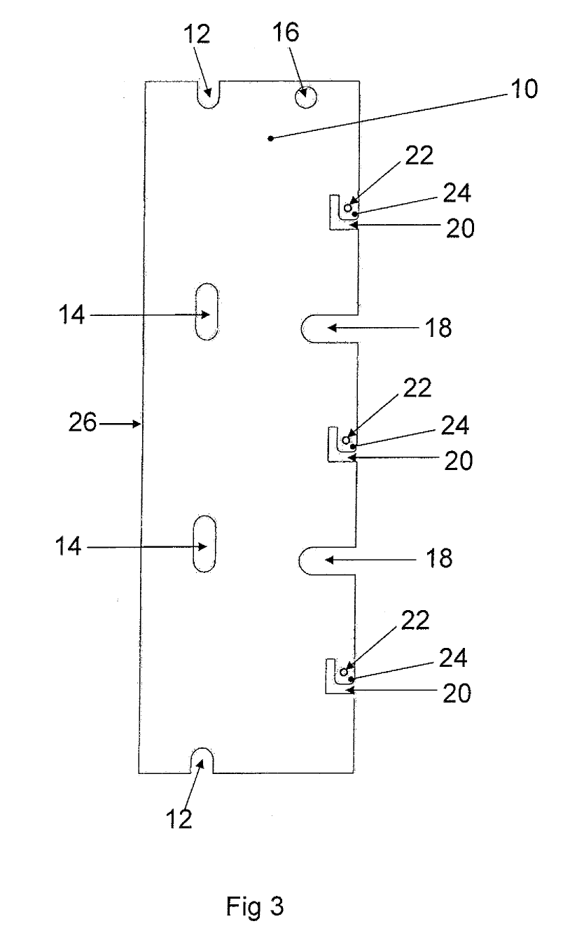

Preferred embodiments of the present invention will now be described with reference to the drawings. In FIG. 1, a first embodiment of planter assembly 2 is shown with accommodation for nine plants, and a second embodiment of a planter assembly 4 with accommodation for thirty six plants is shown in FIG. 2. Each of the planter assemblies 2 and 4 includes a pair of side panels 10;110 a plurality of plant supports 30;130 upper and lower rails 50, 55, 60 and wall brackets 70. Referring to FIG. 3, each side panel 10, 110 is a flat rectangular panel which forms a respective side of the planter assembly 2. The side panels 10 may be conveniently constructed from any suitable sturdy material such as a metal or plastic, for example they may be formed from an aluminium sheet. The side panel 10 has conduit entrances 12, 14, 16, 18 which enable an irrigation conduit such as a hose or pipe to enter the planter assembly in order to provide water and nutrients to the plants housed therein. The conduit entrances are arranged so as to provide several options for watering the plants, in that the water may be delivered by spray or drip onto the top of the plant from a pipe which passes through a forward external conduit entrance 12, or forward internal conduit entrance 14, depending on the vertical location of the plant. Alternatively, water may be delivered by drip to the lower portion of the plant to enable direct uptake through the roots. This is accomplished by pipes which pass through the upper rearward conduit entrance 16 and the intermediate rearward conduit entrance 18.

In the event that two side panels are mounted in a vertical arrangement, the forward external conduit entrance 12 of each side panel 10 will be aligned to form a complete conduit entrance. The forward internal conduit entrances 14 are conveniently shaped so that the irrigation pipe which passes therethrough may be temporarily raised and lowered in order to facilitate the insertion or removal of a plant pot 80.

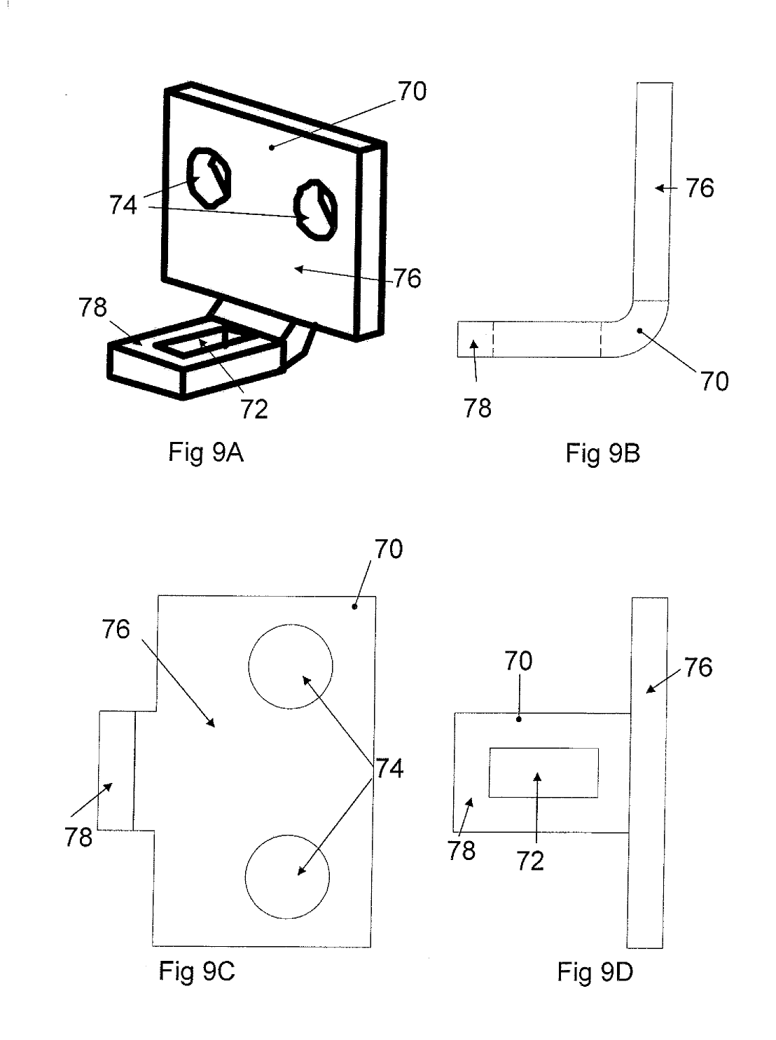

Each side panel 10 may be mounted to a wall by stabilising hooks 24 and wall brackets 70. The stabilising hooks 24 may be formed on a side wall panel 10 in a variety of ways, however, in a preferred embodiment of the invention these are formed by the cutting of an L shaped bracket entrance 20. In use, therefore, a stabilising hook 24 may be supported by a bracket such as a wall bracket 70 (shown in FIG. 9A-D). A stabilising hook 24 may conveniently pass through an aperture 72 in a wall bracket 70, and optionally be secured thereto by passing a locking pin (not shown) such as a cotter pin or a split pin through a locking pin aperture 22. This ensures the stability of the planter assembly.

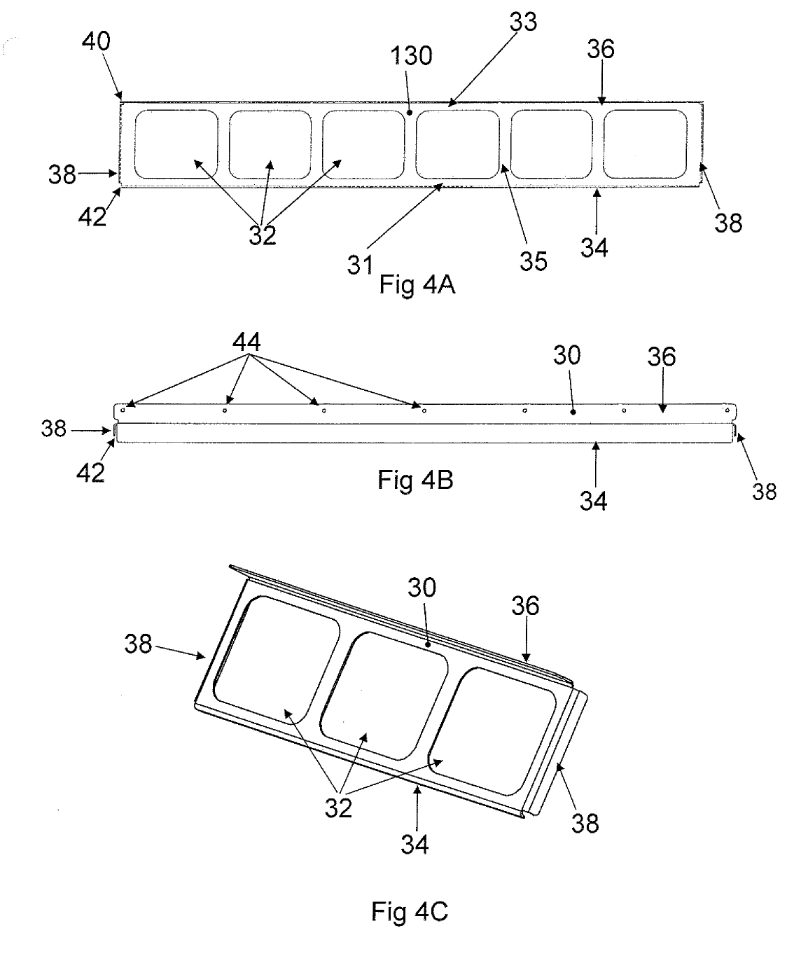

In order to house plants within the planter assembly, there is conveniently provided a plant support 30, 130 as shown in FIG. 4A-C. Although the current invention is not predicated upon any particular size or quantity of plants, each plant support 30 of a first embodiment of the invention (FIG. 1) is adapted to house three plant pots (FIG. 4C), whereas a plant support 130 of the second embodiment (FIG. 2) has been adapted to house six plant pots (FIG. 4A). The plant pots are supported within pot receiving openings 32 in the plant supports 30, 130.

Each plant support 30;130 has front and rear members 31,33 joined by a plurality of spaced transverse members 35. The front and rear members 31, 33 and the transverse members 35 together define the edges of the pot-receiving openings 32.

The plant supports 30,130 may be formed from a range of suitable materials such a metal, eg aluminium, or plastics. As shown in FIG. 4A-C within the plant support are provided pot receiving openings 32. These may be of any of a range of shapes such as circular, oval, square, rectangular or any other polygonal shape. The pot receiving openings 32 of the preferred embodiments of the invention are advantageously square or rectangular. This maximises the planting area of the display and reduces the likelihood of the planter assembly being visible beneath the plant foliage or flowers during use. In order that the plant support 30 is prevented from bending or twisting during use, it is preferable to provide further stability to the plant support. This is accomplished in the preferred embodiments through the introduction of folds or bends into the plant support during the manufacturing process. The bending of a plant support introduces several flanges at the edges of the plant support. At the forward edge there is a downwardly extending front flange 34 as shown in FIG. 4B and FIG. 4C, and at the rear of the plant support there is an upwardly extending rear flange 36 as shown in FIG. 4A-C.

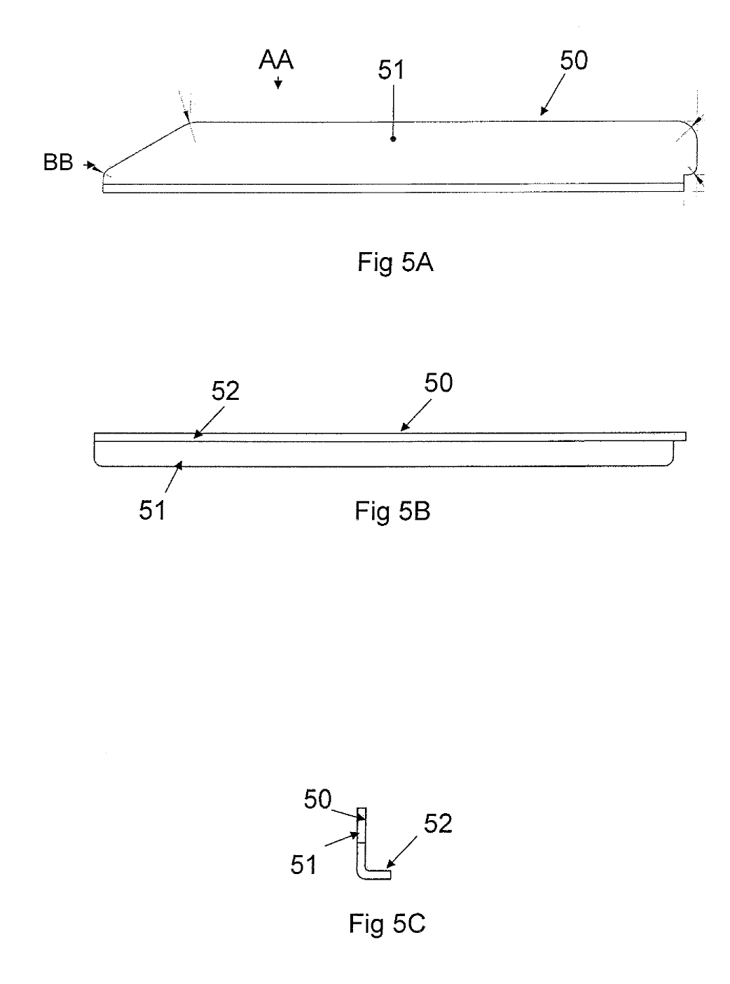

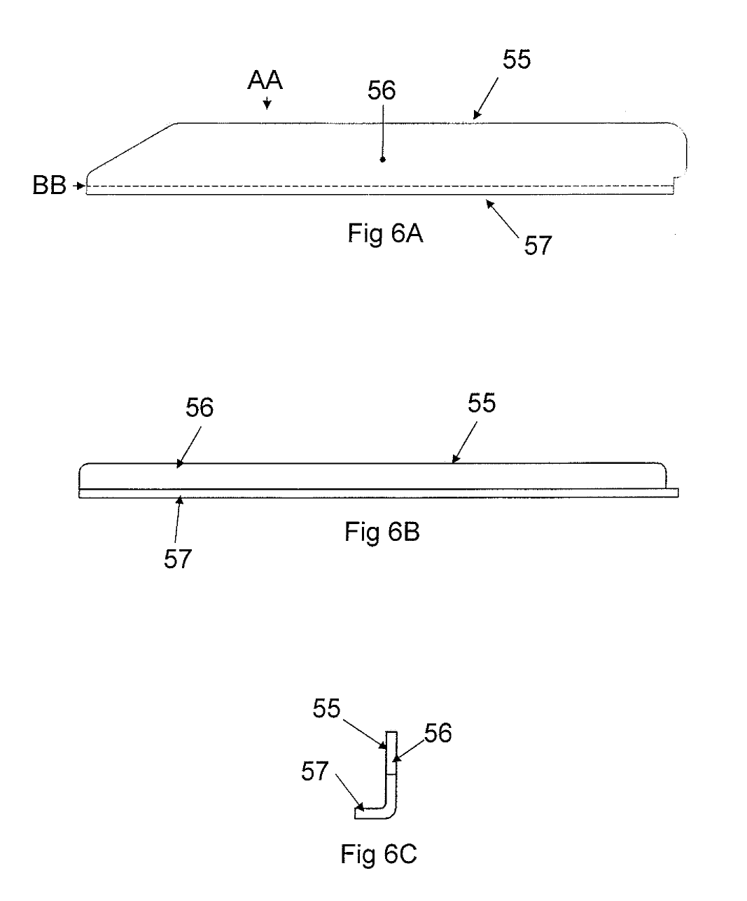

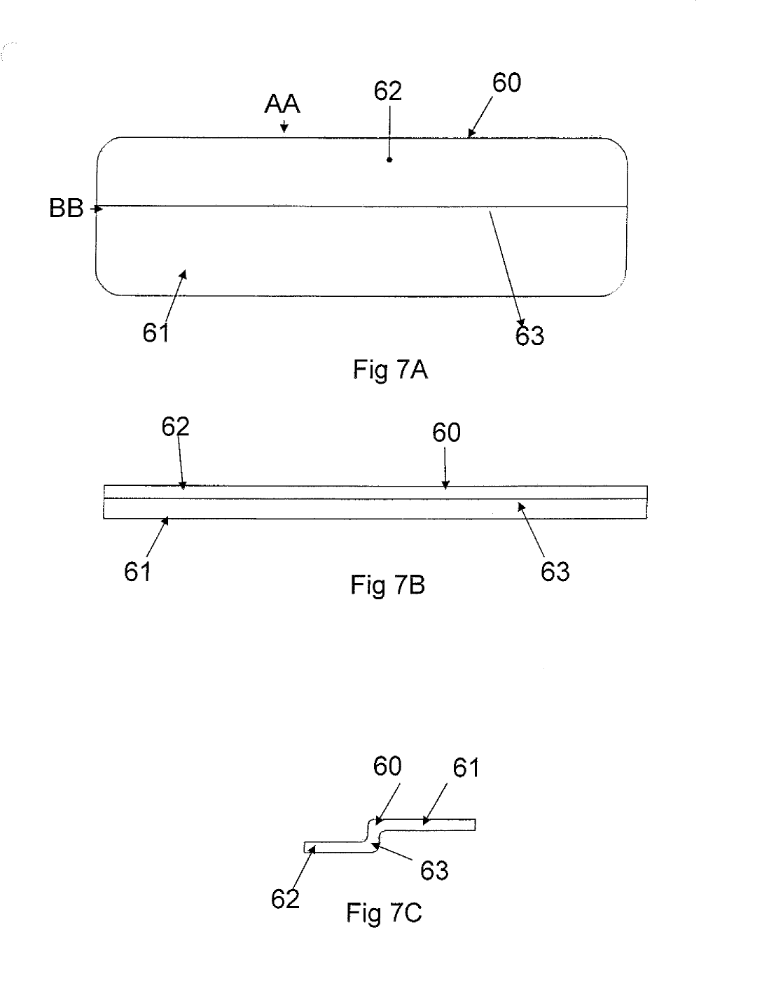

As shown in FIGS. 5 and 6 the upper rails 50, 55 are generally L-shaped, each having a first limb 51, 56 arranged to be mounted on a surface of a respective side panel (10,110) and a second limb 52, 57 extending substantially perpendicularly from the surface of the side panel 10,110. The upper right rail 50 is a mirror image of the upper left rail 55.

In order to assemble a planter assembly 2;4, the plant supports 30 are engaged with the side panels 10. The engagement may be by any suitable means that provides a connection that is sturdy and that can be easily assembled and disassembled by an untrained operator without the need for tools.

In order to facilitate the above engagement, modifications are made to the side panels 10. These modifications take the form of rails that are provided on the side panels 10. An upper right rail 50 (FIG. 5A-5C) is attached to one side panel and an upper left rail 55 (FIG. 6A-6C) is attached to the other side panel. Preferably, two side panels are provided as a set, in order to construct a complete planter assembly. In this instance an upper right rail 50 is attached to the right hand side of a side panel 10 and an upper left rail 55 is attached to the left hand side of the other side panel. In an alternate configuration (not shown) an upper right rail and upper left rail may be attached to opposite surfaces of each side panel, thereby allowing the side by side arrangement of multiple planter assemblies. A further alternative, integral rails may be pressed outwardly from the side panel during manufacture.

Beneath each of the upper right rails 50 and upper left rails 55 is also attached a lower rail 60. Each lower rail 60 collaborates with an upper rail 50, 55 the same lower rail is used on both the left and right sides. Each lower rail 60 has a first flat section 61 and second flat section 62 joined by an intermediate bridging section 63. The first and second flat section 61 extend substantially parallel to each other with the bridging section 63 extending substantially perpendicularly to the first and second sections 61, 62. Thus when the first flat section 61 is attached to a surface of a side panel 10;110 the second flat section 62 stands away from the side panel 10;110 to define a gap for receiving a locking flange 38 located at the end of a plant support.

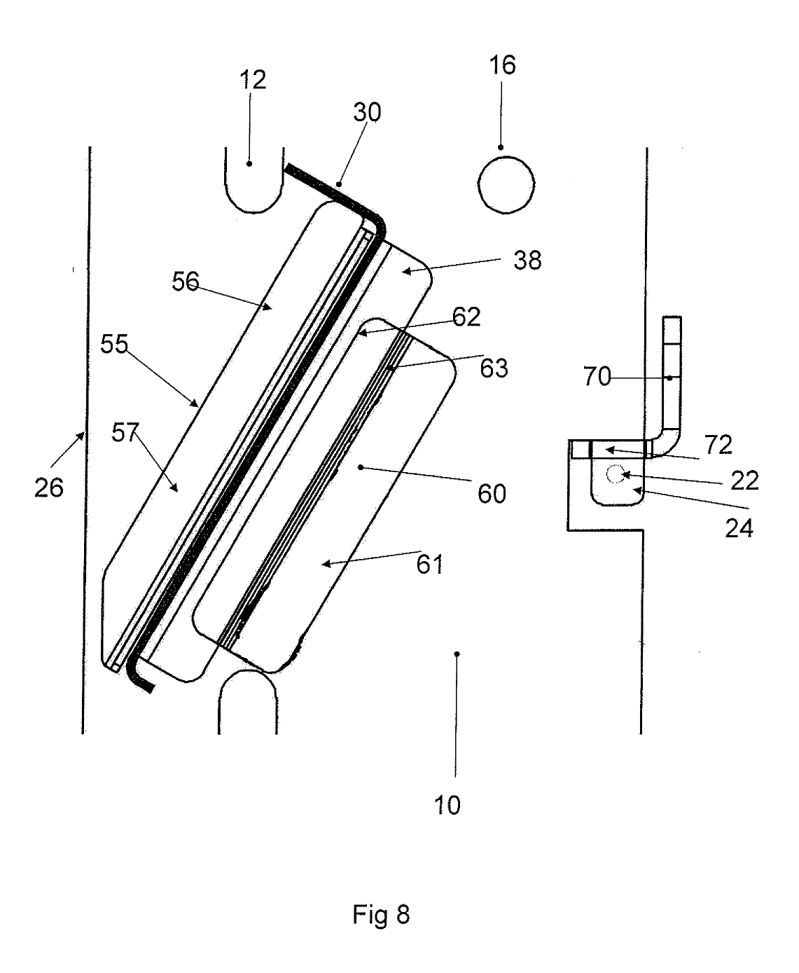

As shown in FIG. 8, an upper left rail 55 and a lower rail 60 are attached to the side panel 10 at specific locations on the side panel during the manufacture of the planter assembly. This attachment may be made by any suitable means, welding being particularly preferable for metal parts.

The arrangement of the upper rails and lower rails is optimised to enable the engagement of the side panel 10 with the plant support 30. When construction of the planter assembly is required, the locking flange 38 slides into the gap between the second flat section 62 of a lower rail 60, and the surface of the side panel 10;110. The upper rails 50, 55 then prevent forward movement of the plant supports 30;130.

As shown in FIGS. 1, 2, 8 and 11, the upper and lower rails 50, 55 and 60 extend at an oblique angle to the longitudinal axis of each associated side panel 10;110 so that when assembled, the transverse members 35 of the plant supports 30; 130 also extend at an oblique angle to the longitudinal axis of each side panel 10;110.

### ASSEMBLY

Once the required parts have been transported to the location at which the botanical display is desired, it is a simple matter for the parts to be arranged to form a complete planter assembly. Side panels and plant supports may be arranged in a variety of suitable combinations. Conveniently, the embodiments of the invention are routinely arranged to house 36 plants per square metre, side panels 10 being provided in two standard sizes, to engage with either 3 or 6 plant supports 30. Additionally, plant supports 30 are also conveniently provided in two standard sizes, accommodating either 3 or 6 plant pots each, depending on the length of the plant supports and the number of pot receiving openings 32 provided therein. It can be readily seen from FIG. 1 that a side panel 10 that can engage with three plant supports 30, each with three pot receiving openings 32, could be assembled to form a planter assembly 2 which could house and display nine plant pots 150. Alternatively, a side panel 110 that is capable of engaging with six plants supports 130, each with six pot receiving openings 32 as shown in FIG. 2, could be assembled to form a planter assembly 4 that could house and display thirty six plant pots 150. In a further alternative configuration, three plant supports 130 may be engaged to a side panel 10 to form a planter assembly which could house and display 18 plant pots 150, and six plant supports 30 may be engaged by side panel 110 to form a planter assembly housing and displaying 18 pots 150.

### IRRIGATION

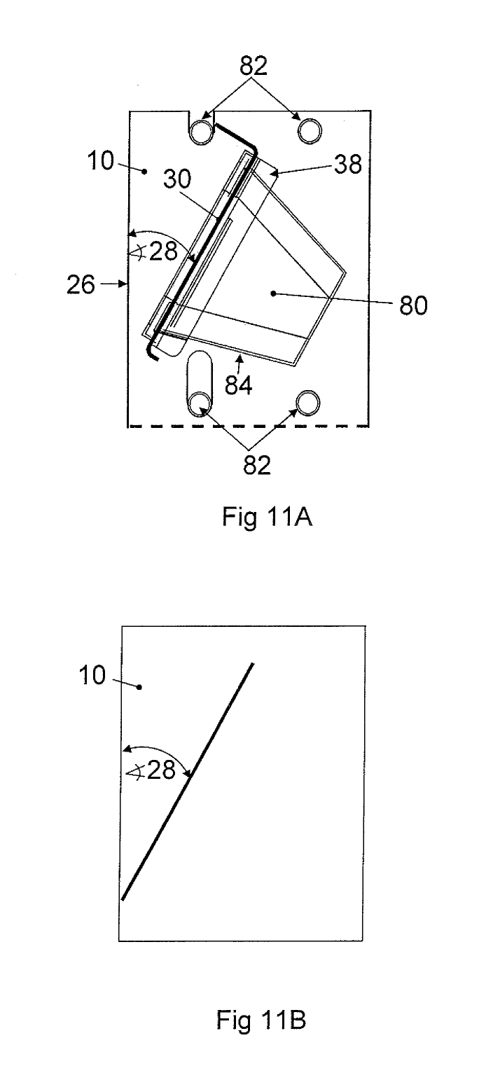

The planter assembly may be conveniently provided with several options to facilitate the provision of water to the plants. The water may also be used to conduct nutrients to the plants as required. The conduit entrances (12,14,16,18) as shown in FIG. 3 allow the passage and support of irrigation conduits 82 (FIG. 11) hoses or pipes. Standard high density polyethylene (HDPE) irrigation pipes are particularly preferred. Having entered the planter assembly through a forward conduit entrance (12,14), each irrigation conduit 82 may then be extended along the corresponding plant support 30. The irrigation conduit 82 may be secured to the rear flange 36 of the plant support 30 by passing standard cable ties (not shown) around the irrigation conduit 82 and through the cable tie apertures 44 that are conveniently located at regular intervals along the rears flange 36 of each plant support 30.

Standard drippers, nozzles, sprays or misters may then be inserted into the irrigation conduit 82 at locations which correspond to the pot entrances 32 to supply water to the plant pot 150 in the desired way.

In an alternate or additional configuration, the irrigation conduits 82 may be caused to enter the planter assembly 2 through the rearward conduit entrances (16 and 18). The water may thereby be supplied to the root zone of the plant pots 150 by drippers which may drip water directly onto the plant pot 80 to be readily absorbed through holes in the plant pot 150. The rear irrigation configuration is particularly advantageous where the minimisation of water loss through evaporation is desirable.

### SETUP, INSERTION AND REMOVAL OF PLANT POTS

Once the desired configuration of planter assembly has been assembled, plant pots 80 may then be inserted into the relevant pot receiving openings 32 of each plant support 30. As shown in FIG. 11, the relative orientation of the plant support 30 to the side panels 10;110 determines the oblique plant angle 28 (FIG. 11B) at which the plant pot is positioned. The plant angle may be defined as the angle between a longitudinal axis of a side panel 10;110, and a line joining a front edge zone and a rear edge zone of a plant support 30;130. In the preferred embodiments shown in FIGS. 1 and 2, the longitudinal axis of the side panels 10;110 extended substantially vertically, a line joining a front edge zone and a rear edge zone of a plant support is parallel to the transverse members 35 of the plant support 30 and also parallel to the upper and lower rails 50, 55, and 60. FIG. 11 B shows how the plant angle 28 can be determined relative to the forward edge 26 of the side panel 10, when the forward edge 26 extends in the direction of the longitudinal axis of the side panel 10. Although any suitable plant angle 28 may be chosen in the manufacture of the planter assembly, an oblique angle of between 10° and 80° is preferred , such as 10°, 20°, 30°, 40°, 50°, 60°, 70° or 80°. More preferably the plant angle may fall substantially in the range from about 20° to about 70°, and most preferably the plant angle is about 30°. Advantageously this provides an optimal visual and aesthetic presentation of the flowers or foliage of the plant, and reduces the visual impact of the plant pot side wall 84 from the forward view of the planter assembly when in use. The overall visual effect of the entire planter assembly is therefore dominated by the plants, while the planter assembly itself is preferably obscured from view. Additional benefit of the optimal plant angle is that the plant is orientated to receive enhanced exposure to sunlight.

This visual effect is enhanced by the shape of the top of the plant pots. Although any suitable shape maybe chosen, square or rectangular shapes are particularly preferred.

Plant pots may be prepared at a remote site or at the site which the planter assembly is to be used. Plants which are sown into the plant pots may be allowed to germinate and grow prior to being placed into the planter assembly. This enables an immediate display effect to be produced once the planter assembly is assembled. Alternatively, plants may be propagated directly into the plant pots at the site where the planter assembly is to be located.

A variety of plants may be accommodated by the assembly, including mosses, climbing plants, trailing plants, grasses, spices, herbs, flowering plants, vegetables and bromeliads.

### PLANT POT

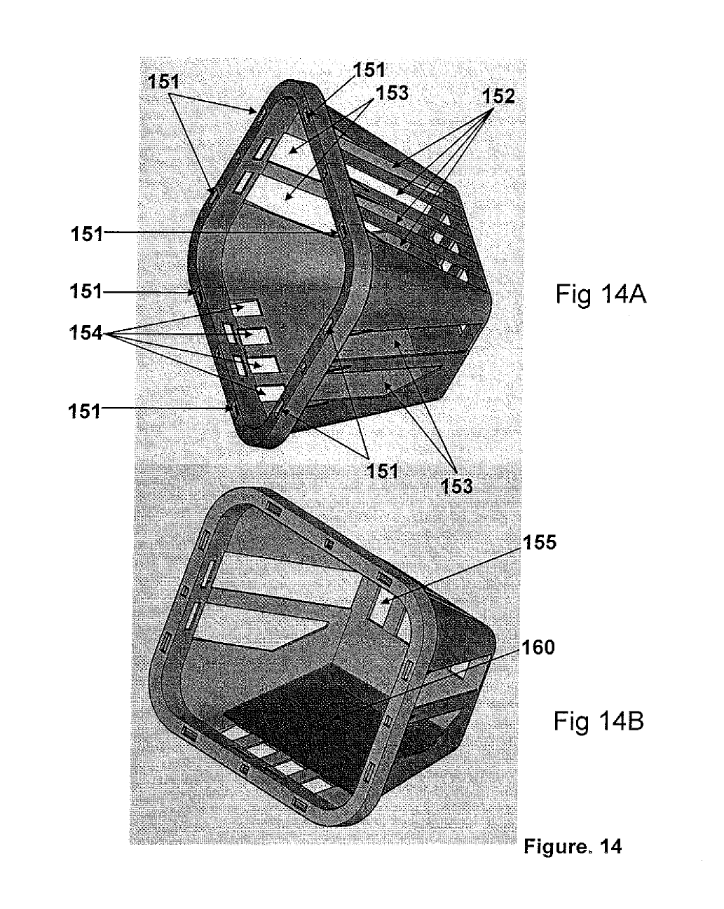

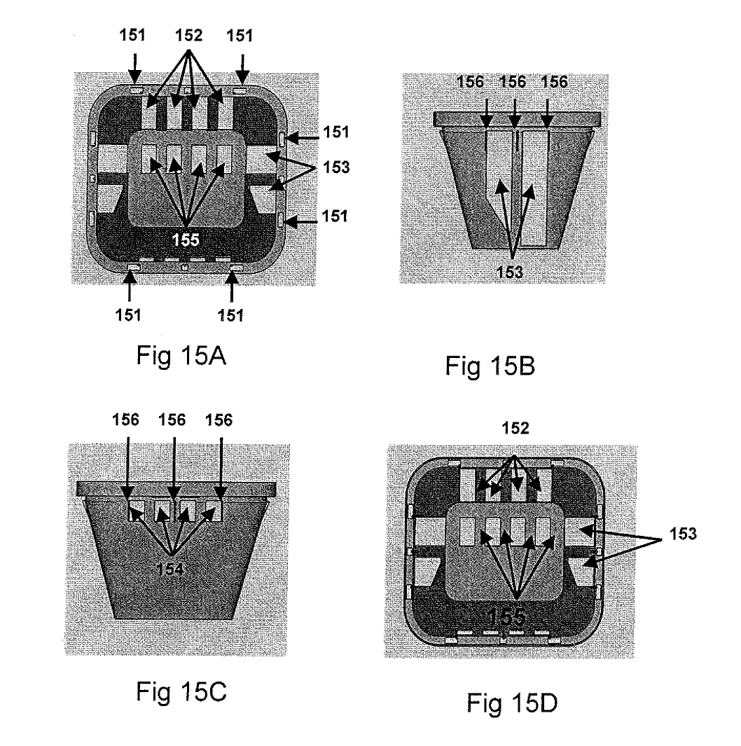

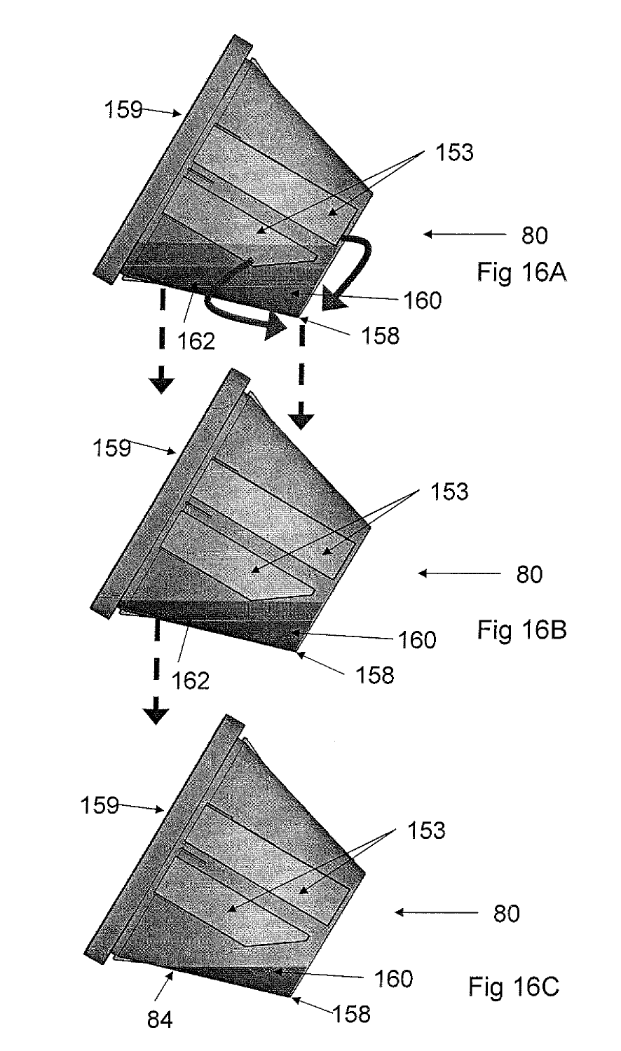

It is also preferable to use a plant pot that has additional apertures on the sides. As shown in FIGS. 14 to 16 when a plant pot is placed at an angle within a planter assembly, one side area becomes an upper side wall and an opposite side area becomes a lower side wall. As shown in FIG. 14A, the plant pot 150 has top apertures 152, side apertures 153, bottom apertures 154, and back apertures 155 such that when placed into a planter assembly water may drip vertically from one pot to another in a controlled way. Advantageously, when the plant pot (150) is placed within a planter assembly at the plant angle 28, a capillarity reservoir 160 is formed in an upper pot in which water may accumulate. The pot configuration is designed to create a capillarity reservoir 160 which will retain an amount of water after the irrigation cycle stops (FIG. 16C). The plant roots can then draw the water up through capillarity into the soil medium and rooting zone above. This provides the plant with a secondary water source after the irrigation cycle has stopped. Excess water 162 may drip through the bottom apertures 154 or back apertures 155 of an upper pot onto a lower pot where the water enters the soil of the lower pot root zone through top apertures 152.

As shown in FIG. 16A, during irrigation or rainfall the pot can drain freely through the side (153), back (155) and bottom (154) apertures. During heavy saturation, water runs along the pot sidewall 84 from the side, back and bottom apertures and drips off the lower edge (158) onto the top apertures (152) of the pot below.

During medium saturation (FIG. 16B), water drains down and drips from the bottom apertures 154 onto the planting surface of the pot below.

The pot also has clip holes 151 and locking lugs 156 to optimise the stability of the pot when in the planter assembly.

If it is necessary or desirable to remove one or several plant pots, this can easily be achieved by temporarily raising the irrigation conduit 82 at a location close to the plant pot 150 and then removing the plant pot 150. This process is conveniently facilitated by the shape of the conduit entrances 12, 14, 16 and 18 which allow vertical movement of the relevant irrigation conduit 82.

### PACKING AND TRANSPORTATION

It will be readily apparent from the forgoing description and figures appended hereto, that the shape of the parts is ideally suited to efficient storage and transport of the planter assembly.

### PRESENTATION

As mentioned hereinbefore, it may be desirable to secure the planter assembly to a wall to prevent toppling or falling or to elevate the planter assembly from the floor. Although this may be achieved by many methods, a wall bracket 70 is conveniently provided according to an embodiment of the invention to facilitate such stabilisation. Alternatively, two planter assemblies 2 may be arranged together in a back to back configuration. This may be either free standing or hanging.

As shown in FIG. 9A-D, the wall bracket 70 may be constructed from any suitable material. Preferably 5 mm galvanised mild steel is used. The wall bracket 70 has wall bracket boltholes 74 in order that the wall bracket can be bolted to a wall or support structure. Alternatively, two wall brackets may be bolted together in a back to back configuration, to allow 2 planter assemblies to be secured together back to back in a free standing location, or with a cable clamped between the two wall brackets to enable two planter assemblies to be suspended together from an overhead support.

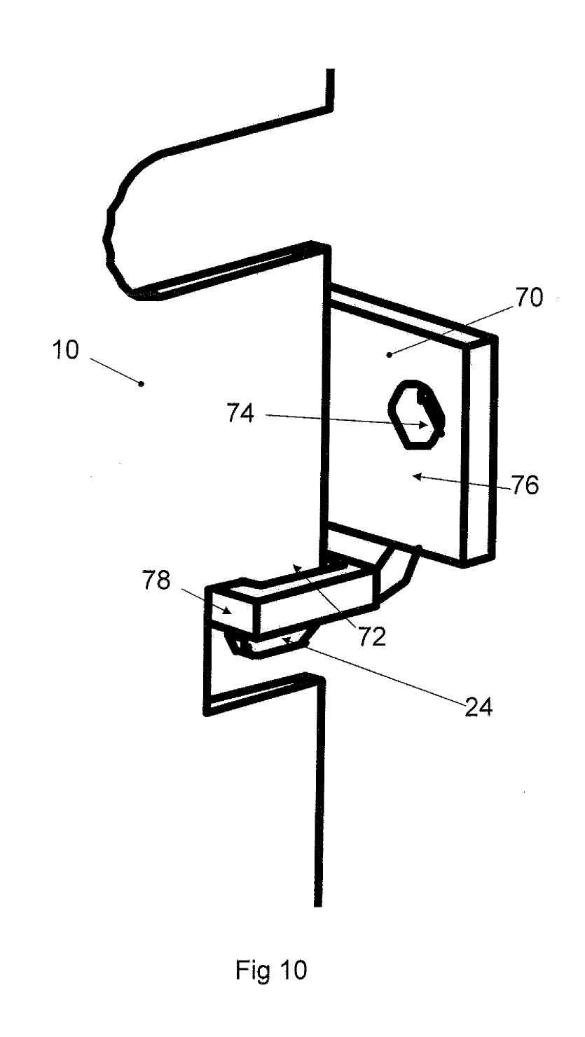

When the planter assembly is to be secured in any of the ways described above, one or more of the stabilising hooks 24 can be engaged into the wall bracket aperture 72 as shown in FIG. 10.

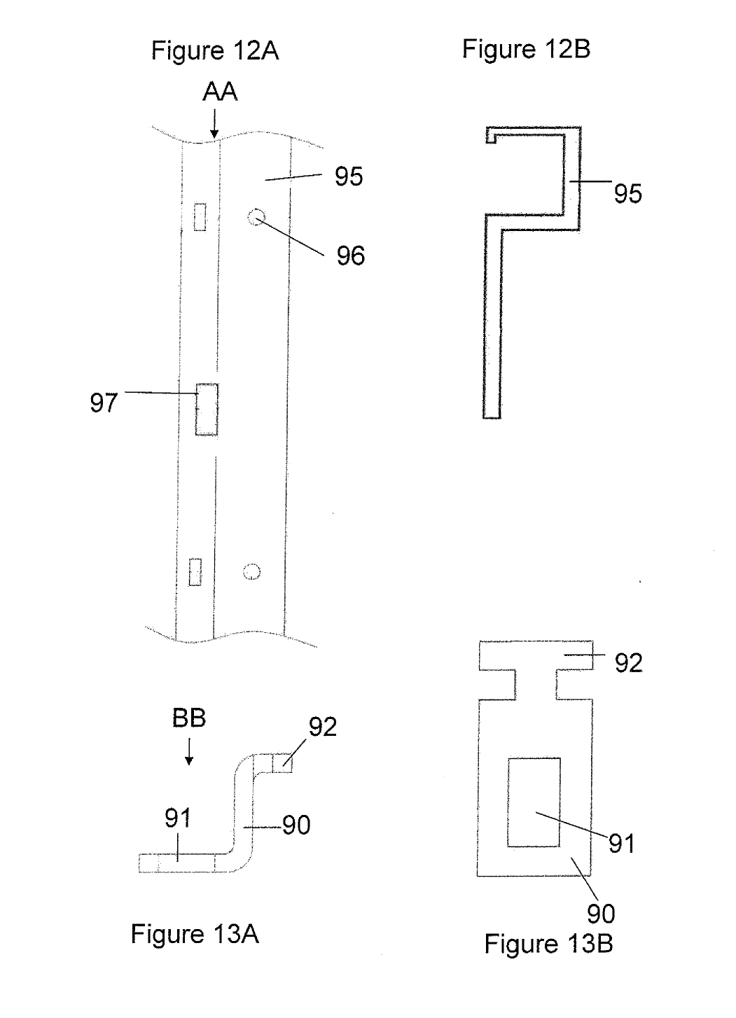

An alternative means of mounting a planter assembly to a wall is through the use of a twist-lock bracket 90 (FIG. 13A, B) and hanging rail 95 (FIGS. 12A,B). A hanging rail of a suitable length may be secured to a substantially vertical support such as a wall, using bolts through apertures 96. The hanging rail may has a flat portion running along the length of the rail that is positioned against the wall. The hanging rail also has a region that is substantially square or rectangular in cross section that also runs along the length of the rail, into which the twist-lock bracket 90 may be secured. A twist-lock bracket 90 has a hammer head shape at one end and an aperture 91 at the other end. The hammer head shape allows the twist-lock bracket to be secured through an aperture 97 located in the square or rectangular cross-section region of the hanging rail 95. The stabilising hook 24 of a side panel 10 may then be inserted through aperture 91 of the twist-lock bracket.

It will be appreciated that various modifications may be made to the specific embodiments of planter assemblies described above without departing from the scope and spirit of the invention.

1. A planter assembly for the growth and/or display of plants comprising at least one side support panel (10; 110) having a longitudinal axis and one or more plant supports (30;130) connected to the at least one side support panel for supporting a plurality of plants in at least one row and/or column extending in a plane at an oblique angle to the longitudinal axis of the at least one side support panel.

2. A planter assembly according to claim 1 wherein the or each plant support (30;130) has a front edge zone and a rear edge zone and a line joining the front edge zone to the rear edge zone extends at an oblique angle (28) to the longitudinal axis of the at least one side support panel (10, 110).

3. A planter assembly according to claim 1 or claim 2 wherein the or each plant support has a plurality of pot receiving apertures (32) for accommodating a plurality of plant pots (150).

4. A planter assembly according to claim 3 wherein the or each plant support has front and rear members (31; 33) extending from the at least one side support panel (10; 110) and a plurality of transverse members (35) joining the front and rear members to define the pot receiving apertures (32).

5. A planter assembly according to claim 4 wherein the transverse members (35) extend at an oblique angle (28) to the longitudinal axis of the at least one side support panel (10;110).

6. A planter assembly according to any one of the preceding claims wherein the at least one plant support (30; 130) is removably attached to the at least one side support panel (10; 110).

7. A planter assembly according to any one of the preceding claims wherein the or each side support panel (10; 110) has at least one rail (50; 60) to which an end of one of the plant supports (30; 130) is attached.

8. A planter assembly according to claim 7 wherein the at least one rail (50; 60) of the side support panel (10; 110) extends at an oblique angle to the longitudinal axis of the side support panel.

9. A planter assembly according to claim 7 or claim 8 wherein locking flanges (38) are provided at the ends of the at least one plant support (30; 130) for removable engagement with the at least one rail (50; 60) of the side support panel (10; 110).

10. A planter assembly according to any one of the preceding claims wherein the or each plant is supported at an oblique plant angle (28) to the longitudinal axis of the at least one side support panel falling substantially within the range from 10° to 80°.

11. A planter assembly according to claim 10 wherein the plant angle (28) of each plant falls substantially within the range from 20° to 70°.

12. A planter assembly according to claim 11 wherein the plant angle (28) is about 30°.

13. A planter assembly according to any one of the preceding claims wherein the side support panels (10; 110) and plant supports (30; 130) may be disengaged and stacked together for space efficient transport and/or storage.

14. A planter assembly according to any one of the preceding claims wherein the assembly includes mounting means (24, 70) for mounting the assembly to a wall, or to at least one rail or cable.

15. A planter assembly according to claim 14 wherein the mounting means includes at least one stabilising hook (24).

16. A planter assembly according to claim 15 wherein the at least one stabilising hook (24) is engageable with a mounting bracket (70;90).

17. A planter assembly according to claim 16 wherein the mounting bracket is a twist-lock bracket (90) for engagement with a mounting rail (95).

18. A planter assembly according to any one of the preceding claims wherein a botanical specimen may be accommodated in the planter assembly without being removed from the plant pot (150) in which it was propagated.

19. A planter assembly according to any one of the preceding claims having apertures and/or recesses in at least one side support panel for irrigation conduits.

20. A planter assembly according to any one of the preceding claims incorporating a plurality of plant pots (150), each plant pot (150) having apertures in at least one side wall to allow the passage of water into or out of the pot.

21. A planter assembly according to claim 20 wherein the plant pots are lined with a porous textile material.

22. Use of a planter assembly according to any one of the preceding claims for the horticultural or agronomic growth and or display of plants.

23. A pot for mounting in a planter assembly having a capillarity reservoir, (160) top apertures (152) and bottom apertures (154) such that when the pot is mounted at an oblique angle, excess water may move from the capillarity reservoir of an upper pot, through the bottom apertures (154) to the top apertures (152) of a lower pot.

24. A planter assembly according to any one of claims 18-21 wherein the pot (150) has a capillarity reservoir (160) top apertures (152) and bottom apertures (154) such that when the pot is mounted at an oblique angle, excess water may move from the capillarity reservoir of an upper pot, through the bottom apertures (154) to the top apertures (152) of a lower pot.
